(19) United States
(12) Patent Application Publication
(10) Pub. No.: US 2013/0265296 A1
(43) Pub. Date: Oct. 10, 2013

(54) Motion Activated Three Dimensional Effect

(71) Applicant: Wing-Shun Chan, Hong Kong (CN)

(72) Inventor: Wing-Shun Chan, Hong Kong (CN)

(21) Appl. No.: 13/440,420

(22) Filed: Apr. 5, 2012

(51) Int. Cl. G06T 19/20; G06F 3/041

(52) U.S. Cl. 345/419; 345/173

(57) ABSTRACT

Methods, apparatus, and computer readable medium for presenting a multilayer image are disclosed. An electronic tablet device may include a display, touch sensor, a motion sensor, and controller. The motion sensor may generate input signals indicative of a spatial movement of the electronic tablet device. The controller may receive the input signals and generate output signals that shifts layers of the multilayer image with respect to other layers of the multilayer image to cause a three dimensional effect that is controlled by spatial movement of the electronic table device.

### FIELD OF THE INVENTION

The present invention relates to image creation and/or editing, and more particular to a toy having the ability to color and display images.

### BACKGROUND OF INVENTION

One type of image creation and/or editing program geared toward children is a coloring book program. A child using such a coloring book program typically adds color to a predefined collection of line art drawings. For example, in some coloring book programs, a child may select a line art drawing from a predefine collection, select an enclosed region of the selected drawing, and select a color to add to the selected region. In response to such selections, the coloring book program may fill the selected region with the selected color. Other coloring book programs attempt to more closely mimic the process of coloring a page in a conventional coloring book. In such color programs, a user selects a color for a brush or other coloring tool and colors a selected line art drawing by moving the brush across the drawing via an input device such as a mouse, drawing pad, or touch screen.

Many children find such coloring book programs entertaining. However, in many aspects, such coloring book programs do not take advantage of the platform to deliver an enhanced experience. As a result, many coloring book programs add little to the conventional coloring book experience.

### SUMMARY OF INVENTION

Aspects of the present invention are directed to methods, systems, and apparatus, substantially as shown in and/or described in connection with at least one of the figures and as set forth more completely in the claims.

These and other advantages, aspects and novel features of the present invention, as well as details of illustrative aspects thereof, will be more fully understood from the following description and drawings.

### BRIEF DESCRIPTION OF THE DRAWINGS

FIG. 1 is a diagram that illustrates a toy in the form of an electronic tablet device which may incorporate various aspect of the present invention.

FIG. 2 is a simplified hardware diagram of the electronic tablet device of FIG. 1.

FIG. 3 shows aspects of an enhanced coloring book program for the electronic tablet device of FIG. 1.

FIG. 4 shows a flowchart depicting aspects of the enhanced coloring book program of FIG. 3.

FIGS. 5A-5C show aspects of a multilayer image of the coloring book program associated with FIGS. 3 and 4.

FIG. 6 shows a flowchart depicting aspects of a three-dimensional effect presented by the coloring book program of FIGS. 3 and 4.

### DETAILED DESCRIPTION

Aspects of the invention may be found in a method, apparatus, and computer readable storage medium that permit coloring line art drawings and/or exhibiting three-dimensional aspects of such drawings in response to spatial movement (e.g., up, down, left, right, tilting, shaking, etc.) of the computing device itself. In some embodiments, an electronic tablet device may execute instructions of a coloring book program and/or three-dimensional rendering program in order to permit a user to color a drawing and/or display three-dimensional aspects of a drawing via spatial movement of the electronic tablet device. In particular, the electronic tablet device may provide a canvas upon which is displayed a line art drawing, colors to apply to the drawing, and/or tools to apply such colors to the drawing. The electronic tablet device may further include an accelerometer or other type of motion sensor in order to detect a spatial movement of the electronic tablet device. In response to such detected movement, the electronic tablet device may move aspects of the drawing in relation to other aspects of the drawing to effect a three-dimensional effect. In this manner, background portions of the drawing that were hidden or obscured by other portions of the drawing in the foreground may be revealed based upon the spatial movement of the electronic tablet device.

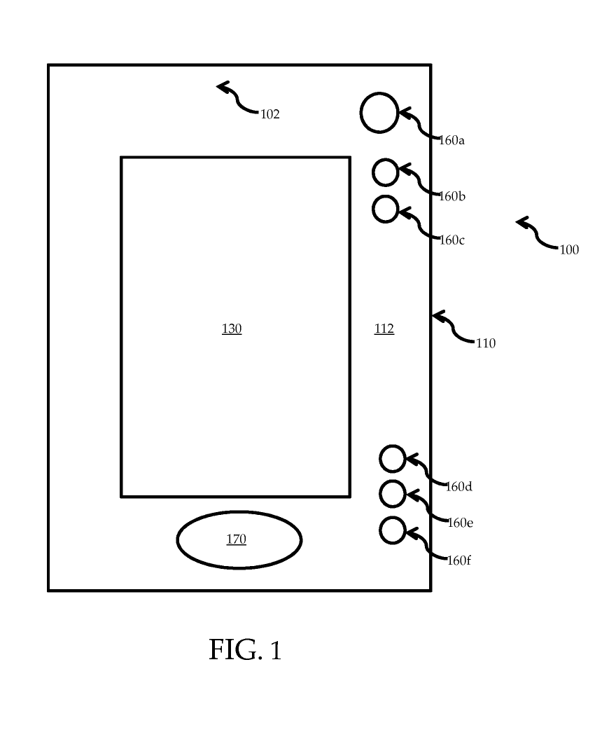

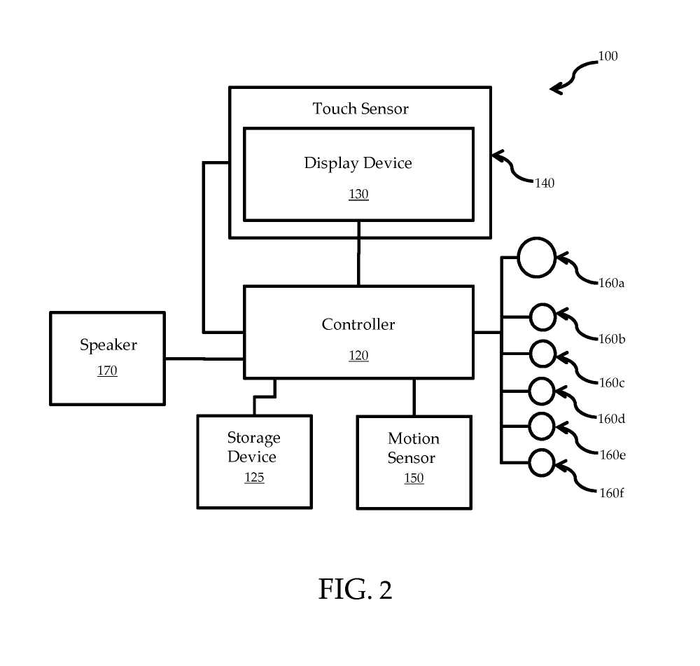

Referring now to FIGS. 1 and 2, an electronic tablet device 100 is shown which may incorporate various aspects of the present invention. While various aspects of the present invention are described in relation to a toy in the form of an electronic tablet device, it should be appreciated that various aspects of the present invention may be suited for other types computing devices, such as smart phones, personal digital assistants, audio players, handheld gaming devices, etc.

As shown, the tablet 100 may include a housing 110, a controller 120, a storage device 125, a display device 130, a touch sensor 140, a motion sensor 150, push buttons 160a-f, and a speaker 170. The housing 110 may include various rubber, plastic, metal, and/or other materials suitable for (i) encasing electrical components of the tablet 100, such as those depicted in FIG. 2, (ii) seating other components of the tablet 100 such as buttons 160a-f, and (iii) structurally integrating the various components of the tablet 100 to one another.

The controller 120 may include processing circuitry and control circuitry. In particular, the processing circuitry may include a central processing unit, a micro-processor, a micro-controller, a programmable gate array, and/or other processing circuitry capable of processing various input signals such as, for example, input signals from touch sensor 140, motion sensor 150, and push buttons 160a-f. The controller 120 may be further configured to generate various output signals such as, for example, video output signals for the display device 130 and audio output signals for the speaker 170.

The storage device 125 may include one or more computer readable storage media such as, for example, flash memory devices, hard disk devices, compact disc media, DVD media, EEPROMs, etc suitable for storing instructions and data. In some embodiments, the storage device 125 may store an enhanced coloring book program comprising instructions that, in response to being executed by the controller 120, provide a user of the tablet 100 with the ability to color line art drawings and/or exhibit three-dimensional aspects of such drawings in response to spatial movement (e.g., up, down, left, right, tilting, shaking, etc.) of the tablet 100 itself.

The display device 130 may present or display graphical and textual content in response to one or more signals received from the controller 120. To this end, the display device 130 may include an light-emitting diode (LED) display, an electroluminescent display (ELD), an electronic paper (E Ink) display, a plasma display panel (PDP), a liquid crystal display (LCD), a thin-film transistor display (TFT), an organic light-emitting diode display (OLED), or a display device using another type of display technology.

As shown, the display device 130 may span a considerable portion of a front surface or side 102 of the tablet 100 and may be surrounded by a bezel 112 of the housing 110. Thus, a user may hold the tablet 100 by the bezel 112 and still view content presented by the display device 130. Moreover, the housing 110 may further include a stand (not shown) that pops-out from a back surface of the tablet 100. The stand may permit the user to stand the tablet 100 on a table or another horizontal surface in order to view content presented by the display device 130.

The touch sensor 140 may overlay the display device 130 and provide the controller 120 with input signals indicative of location (e.g., a point, coordinate, area, region, etc.) at which a user has touched the screen 140 with a finger, stylus, and/or other object. Based upon touch input signals, the controller 120 may identify a position on the display device 130 corresponding to the touched location on the touch sensor 140. To this end, the touch sensor 140 may be implemented using various different touch sensor technologies such as, for example, resistive, surface acoustic wave, capacitive, infrared, optical imaging, dispersive signal, acoustic pulse recognition, etc. Moreover, in some embodiments, the tablet 100 may include a touch sensor, in addition to or instead of the touch sensor 140, that does not overlay the display device 130. In such embodiments, the touch sensor may be a separate device that operably couples to the controller 120 of the tablet 100 via a wired or wireless connection.

As shown in FIG. 2, the tablet 100 may further include a motion sensor 150 configured to provide the controller 120 with input signals indicative of spatial movement (e.g., up, down, left, right, angle of tilt, shaking, etc.). To this end, the motion sensor 150 may include a multi-axis accelerometer capable of detecting magnitude and direction of acceleration as a vector quantity and to generate input signals for the controller 120 that are indicative of such detected vector quantity. Thus, the motion sensor 150 permits the controller 120 to detect spatial movement of the tablet 100 as a whole. For the sake of clarity, the motion sensor 150 contemplated by the present application and the appended claims detects movement of the tablet 100 as a whole instead of merely detecting movement of an input device (e.g., joystick, mouse, D-pad (direction pad), button, etc.) that may be actuated and manipulated in relation to the tablet 100. From the view point of the user, the tablet 100 itself becomes the input device as spatial movement of the tablet 100 (e.g., tilting forward) results in a corresponding input to the controller 120.

Besides the touch sensor 140 and motion sensor 150, the tablet 100 may further include push buttons 160a-f in order to provide the controller 120 with additional input signals. Various embodiments of the tablet 100 may include additional and/or fewer additional input devices such as push buttons 160a-f, switches, sliders, etc. in order to provide the controller 120 with further input signals. However, it should be appreciated that many if not all of such push buttons 160a-f and/or other input devices may be eliminated. The functions performed by such eliminated input devices may be implemented by the touch sensor 140 and/or motions sensor 150 or may be simply removed from some embodiments.

The push buttons 160a-f may be seated in housing 110 and configured to provide controller 120 with an input signal in response to being activated. As such, push buttons 160a-f may provide a user of the tablet 100 with the ability to trigger certain functionality of the tablet 100 by merely actuating the respective button. For example, the push buttons 160a-f may include a power button 160a, a home button 160b, a help button 160c, a volume-up button 160d, and volume down button 160e, and a brightness button 160f. The power button 160a may toggle the tablet 100 between powered-on and powered-off states. The volume-up and volume-down buttons 160d, 160e may respectively cause the controller 120 to increase and decrease audio output signals to the speaker 170. The brightness button 160f may cause the controller 120 to adjust a brightness level of the display device 130. The home button 160b may request the controller 120 to present a home or default menu on the display device 130 and the help button 160c may request the controller 120 to present help information via the display device 130 and/or the speaker 170.

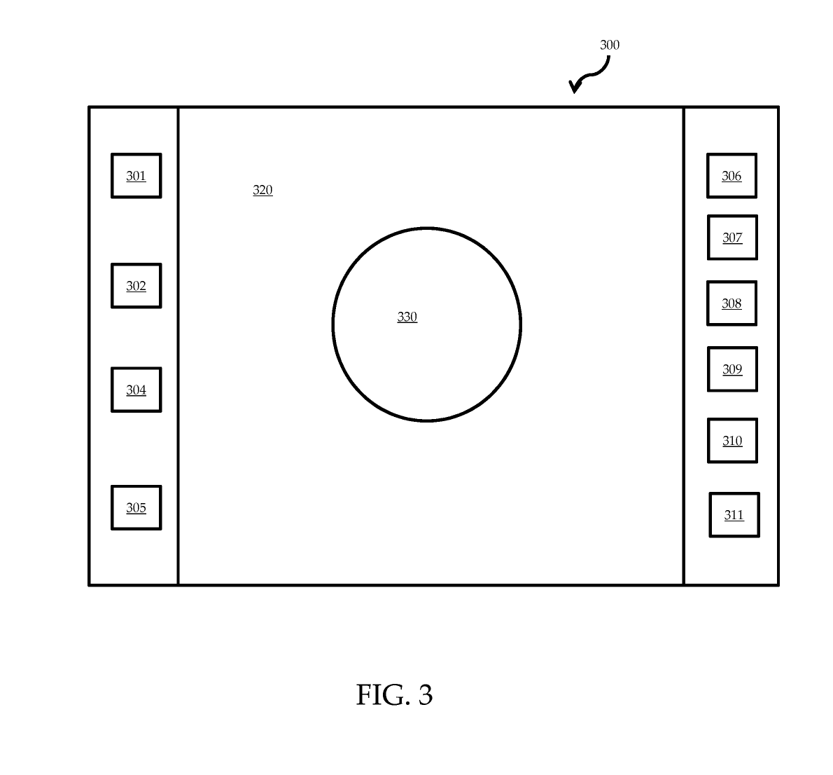

Referring now to FIG. 3, a main screen 300 of a coloring book program with a three-dimensional effect is shown. In particular, the main screen 300 includes controls 301-311 and a viewing window 320. The controls 301-311 provide a user with the ability to control various aspects of coloring a multi-layer image 330 depicted in the viewing window 320. In one embodiment, the controls 301-311 are virtual buttons which a user may activate by touching the respective control via the touch sensor 140. In response to being activated, the controls 301-311 may pop-up a dialog window or slide out a drawer via which the user may make additional selections (e.g., color, file name, storage location, etc.) associated with the activated control 301-311.

In the interest of brevity, the specification and claims may generally refer to touching a control or other item depicted on the display device 130. However, it should be appreciated that the user's finger, stylus, or other object does not in fact touch the graphical representation of the control or item depicted on the display device 130. Instead, the finger, stylus, or other object may contact a protective coating, covering, or possibly the touch sensor 140 itself which is positioned over of the display device 130. The touch sensor 140, in response to such touching, may generate input signals indicative of a location (e.g., point, coordinate, area, region, etc.) associated with the touch on the touch sensor 140. The controller 120 may then determine based upon the input signals which displayed item the user was attempting to touch.

In one embodiment, the main screen 300 may include control buttons such as a new page button 301, an activate button 302, an undo button 304, and a music on/off button 305. A user may touch the new page button 301 to select a new multilayer image from a collection of predefined multilayer images. A user may touch the activate button 302 to activate a three-dimensional effect of the selected multilayer image. When activated, a user may tilt the tablet left, right, up, or down to cause one or more layers of the displayed multilayer image to move in relation to movement of the electronic tablet device 100 to simulate a three-dimensional effect as described in greater detail below.

The user may touch the undo button 304 to undo the most recent change made to the image 330. In some embodiments, the undo button 304 may enable the user to undo or backtrack multiple changes to the image 330. The user may also touch the music on/off button 305 to toggle background music between an on state and an off state.

The main screen 300 may further include a color selection tool, which in one embodiment, includes a plurality of paint buckets 306-311 that each display a different color of paint that may be applied to the displayed multilayer image. In particular, a user may touch the a paint bucket 306-311 to select a corresponding color of paint. In one embodiment, only a portion of the available colors are displayed at a time. A user may scroll the paint buckets 306-311 up and down via the touch sensor 140 to reveal additional color selections. After selecting a paint bucket 306-311 and its corresponding color of paint, the user may touch a region of the displayed multilayer image to apply the selected color to the selected region.

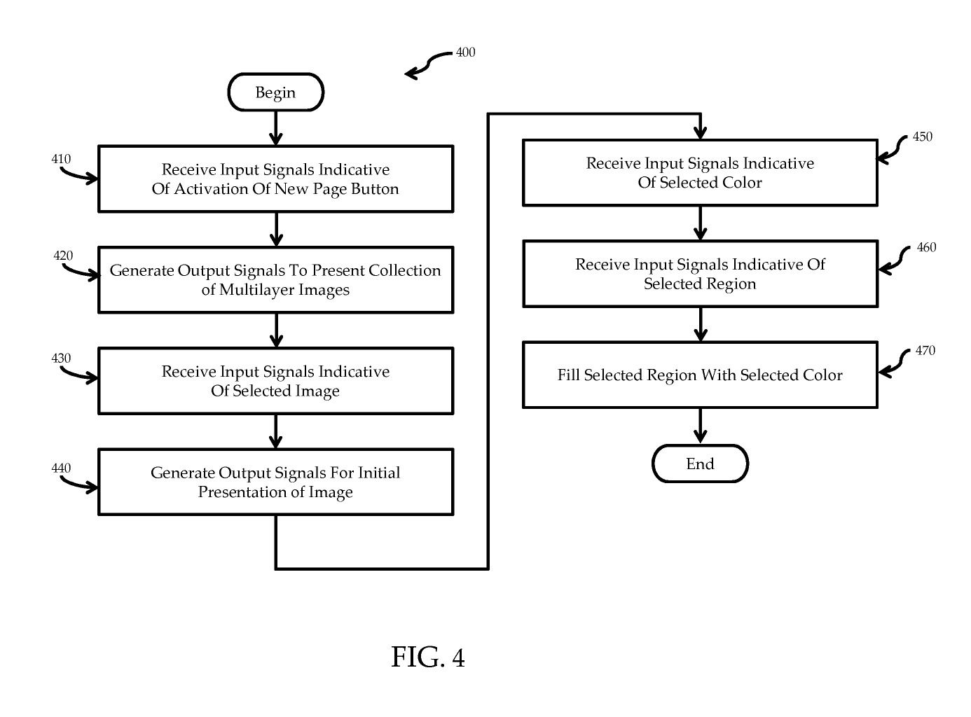

A method 400 of coloring a multilayer image 330 is shown in FIG. 4. In one embodiment, the method 400 is performed by controller 120 in response to executing instructions of a coloring book program. In particular, the controller at 410 may receive input signals indicative of the new page button 301 of main coloring book program screen 300 being touched or otherwise selected. In response to such input signals, the controller 120 at 420 may present via the display device 130 a collection of multilayer images, and at 430 may receive input signals indicative of a multilayer image of the collection being touched or otherwise selected. At 440, the controller 120 may present an initial presentation of the selected multilayer image on the display device 130. At 450, the controller 120 may receive input signals indicative of a paint bucket 306-311 being touched or otherwise selected. At 460, the controller 120 may receive input signals indicative of a visible region or a visible portion of a region of the multilayer image 330 being touched or otherwise selected.

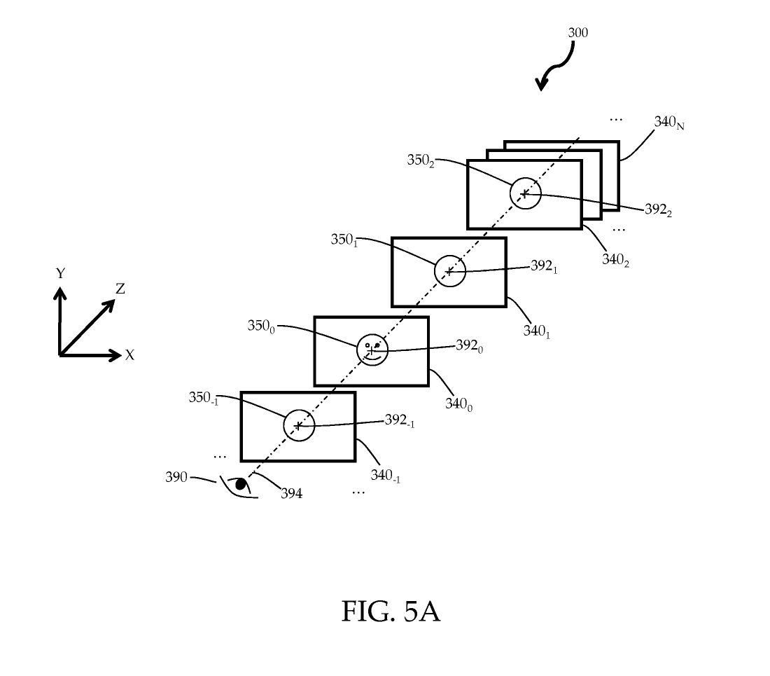

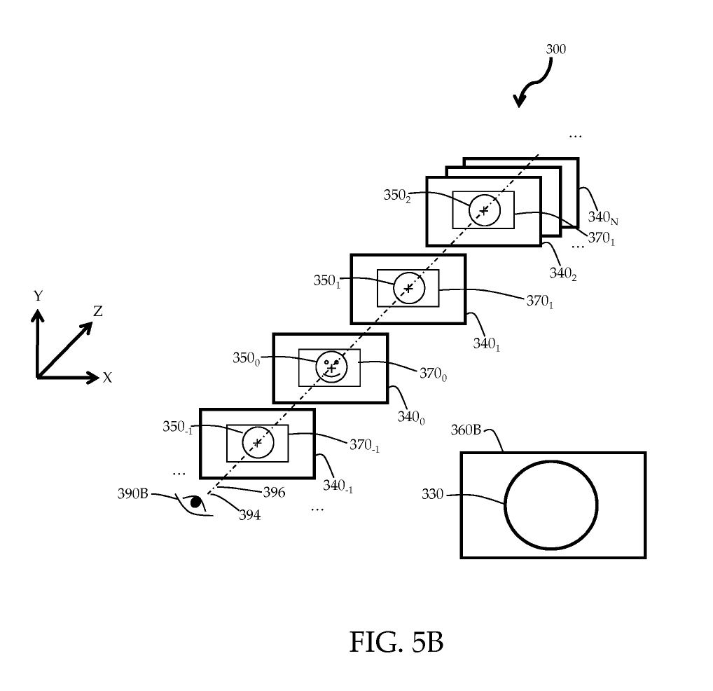

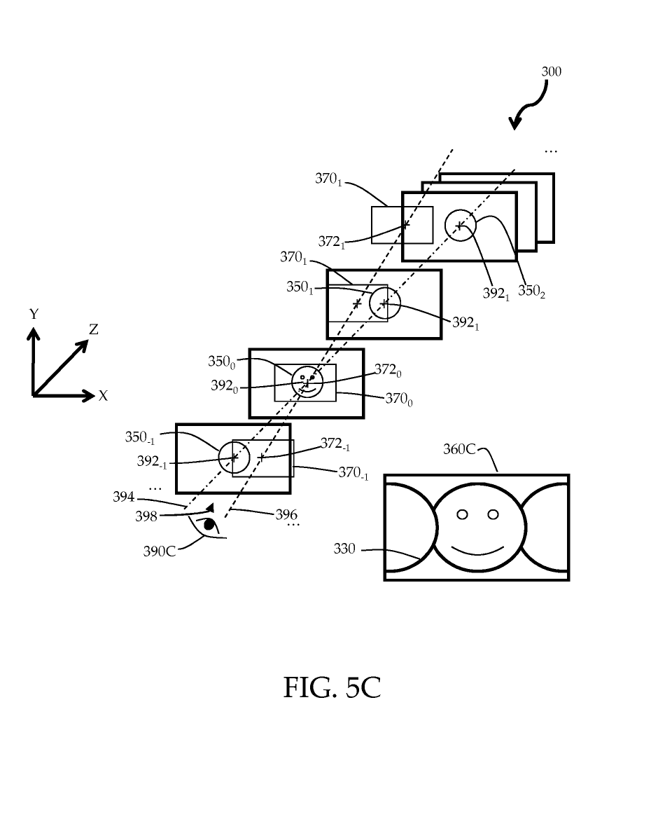

As shown in FIGS. 5A-5C, the multilayer image 330 presented and colored by the method 400. In one embodiment, the image 330 includes a plurality of image layers 340. As a result, when the user touches a point of the multilayer image 330, the controller 120 at 460 may identify which image layers 340₋₁ to 340_{N} correspond to the touched point, and fill with color at 470 the defined region associated with the front-most layer of the identified image layers 340₋₁ to 340_{N}. In particular, as shown in FIGS. 5A-5C, each layer 340₋₁ to 340_{N} may include an image 350-1 to 350₂-comprising one or more predefined regions or objects that may be filled with a selected color. Moreover, as depicted, the plurality of image layer 340₋₁ to 340_{N} have a display order in which layers further up in the image stack (e.g., layer 340₋₁ being the top-most layer of FIGS. 5A-5C) are displayed on top of image layers further down in the stack (e.g., layer 340_{N} being the bottom-most layer in FIGS. 5A-5C).

Due to this display order, images in upper layers may overlap and/or hide regions or portions of regions in lower layers. For example, as shown in FIG. 5B, the circle image 350₋₁ of layer 340₋₁ is displayed on top of the smiley face image 350₀ of layer 340₀, thus completely hiding the smiley face image 350₀ from the resulting presentation 360B of the layers 340₋₁ to 340_{N} on the display device 130. However, FIG. 5C shows another presentation 360C of layers 340-i to 340N on the display device 130 in which the circle image 350₋₁ of layer 340₋₁ overlaps and hides a relatively small portion of the smiley face image 350₀ of layer 340₀, and the smiley face image 350₀ overlaps and hides a relatively small portion of the circle image 350₁ of layer 340₁.

Accordingly, when the user touches a point of the multilayer image 330, the point generally corresponds to a point in each layer 340-1 to 340_{N}. The images 350-1 to 350₂ may be implemented with one or more predefined fillable regions that may be selected and filled with a selected color. However, not all layers 340₋₁ to 340_{N} may have a fillable region associated with the touched point. A particular presentation of the multilayer image 330 may include visible regions, hidden regions, and regions having both visible portions, and hidden portions. See, e.g., presentation 360C of FIG. 5C. Accordingly, the controller 120 at 460 may identify, based upon the current presentation of the image 330, image layers 340 that have a fillable region corresponding to the touched point. The controller at 460 may further select the fillable region associated with the top-most layer of the identified image layers with a fillable region corresponding to the touched point.

In response to selecting the fillable region, the controller 120 at 470 may then fill the selected region with the selected color. In one embodiment, the coloring book program fills both the visible and the hidden portions of the selected region with the selected color.

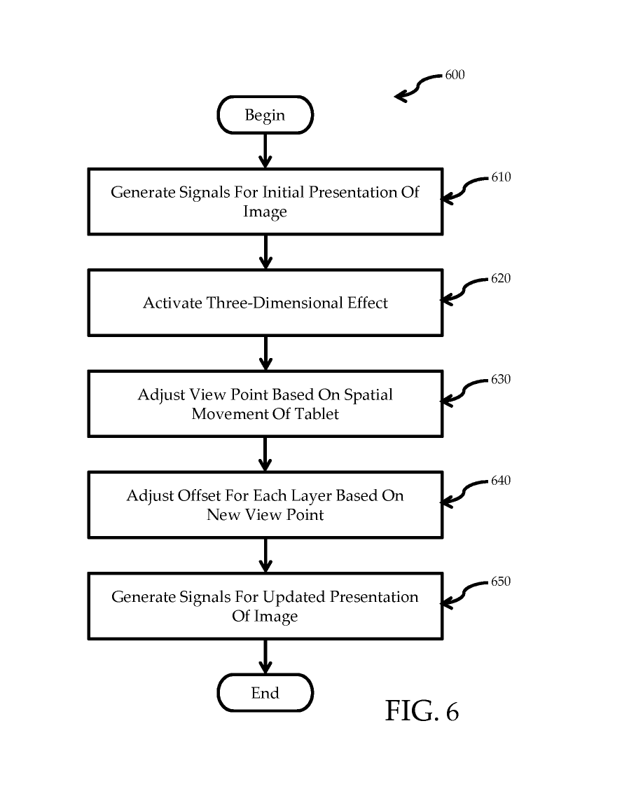

Such filling of hidden portions enhances the three-dimensional effect presented by the tablet 100 in response to spatial movement of the tablet 100. In particular, as shown in method 600 of FIG. 6, the controller 120 may generate one or more output signals that result in the display device 130 displaying an initial presentation 360B of a multilayer image 330. The initial presentation 360B may be based on an initial viewing angle 380 of the image 330, an initial viewing point 390, a reference layer (e.g. layer 340₀), a reference point 392₀, associated depth for each layer 340₋₁ to 340_{N}, an initial offset for each layer 340₋₁ to 340_{N}, and/or an associated viewing window 370₋₁ to 370₂ for each layer 340₋₁ to 340_{N}. It should be appreciated from the following, that the initial presentation 360B and updated presentation 360C may be determined from a subset of the above parameters since many of the parameters are geometrically related and may be determined from other such geometrically related parameters.

As shown in FIGS. 5A-5C, the layers 340₋₁ to 340_{N} may be at different depths. In one embodiment, such depths are based on a Cartesian coordinate system having with an origin layer and/or origin point that define an origin of the coordinate system. The layers 340-1 and 340N in such an embodiment may be positioned at different depths along the z-axis of FIGS. 5A-5C. For example, in FIGS. 5A-5C, image layer 340₀ may be positioned at the origin layer and its reference point 392o may define the origin point of the coordinate system. However, a multilayer image 330 may have an origin layer and/or origin point that does not correspond to a layer of the image. For example, such an image may include layers above or in front of the origin point and layers 340 below or behind the origin point, but no layer at the origin point.

As shown in FIGS. 5A-5C, each layer 340₋₁ to 340_{N} of the multilayer image 330 may have a reference point 392₋₁ to 392₂ that lies on a reference line 394. Moreover, the controller 120 generates presentations of the multilayer image 330 based on a view point 390 that creates a view line 396 that passes through the origin point 392o of the multilayer image 300 and defines a view angle 398 with respect to the reference line 394

As further shown in FIGS. 5A-5C, the reference line 394 passes through a reference point 372₋₁ to 372₂ of a viewing window 370₋₁ to 370₂ associated with each layer 340₋₁ to 340_{N}. Each viewing window 370₋₁ to 370₂ basically maps or projects the corresponding image layer 340₋₁ to 340_{N} to the viewing window 320 of the main screen 300. In particular, the viewing window 370₋₁ to 370₂ selects a portion of its image layer 340₋₁ to 340₂ to be used in the present presentation of the image. FIG. 5B shows the image 330 where the view point 390 is positioned such the reference line 394 and view line 396 align, thus resulting in the reference points 372₋₁ to 372₂ of the viewing windows 370₋₁ to 370₂ aligning with the reference points 392₋₁ to 392₂ of the image layers 340₋₁ to 340_{N}. As such, the depicts circular region of the top-most layer 340₋₁ aligns with the circular regions of the other layers 340₀ to 340_{N}, thus resulting in the presentation 360B of FIG. 5B.

From FIGS. 5A-5C, it should be clear that if the view point 390 is changed, the view line 396 and view angle 398 change as well. Such a change in the view line 396 and view angle 398 causes a shift in the viewing windows 370-i to 370₂ as the controller 120 maintains the reference points 372₋₁ to 372₂ of such windows on the view line 396. For example, if the view point 390 is moved to the right along the x-axis from point 390B shown in FIG. 5B to the point 390C shown in FIG. 5C, such movement of the view point 390 results in a shift in the viewing windows 370₋₁ to 370₂ that is dependent upon its distance from the origin and whether it is above or below the origin.

More specifically, as shown in FIG. 5B, as the view point 390 is moved to the right, windows such as window 370₋₁ which lie above the origin also shifts to the right; however, the magnitude of such a shift is dependent on its distance from the origin. The further from the origin the larger the shift. Conversely, as the view point 390 is move to the right, windows such as windows 370₁ and 370₂ that lie below shift to the left. Again, the magnitude of the shift is dependent on its distance from the origin. The further from the origin the larger the shift. While FIGS. 5B and 5C show a shift of the view point to the right, it should be appreciated that the view point may also be shifted in up or down along the y-axis with windows above the origin moving in the same direction as the view point and windows below the origin moving in the opposite direction.

Referring back to FIG. 6, after generating output signals for presentation 360B, the controller 120 at 620 may activate the three-dimensional effect in response to input signals indicative of a such of the activate button 302 being touched or otherwise selected. At 630, the controller 120 may receiving input signals from motion sensor 150 that are indicative of spatial movement or a spatial orientation of the tablet 100 and adjust the view point 390 accordingly. For example, in response to the user tilting the tablet to the left, the controller 120 may move the view point to the right as depicted in the movement of the viewpoint 390 from point 390B to point 390C in FIGS. 5A-5C.

At 640, the controller 120 may adjust an offset for each layer 340₋₁ to 340_{N} of the multilayer image 330 based upon the new view point. In particular, the controller 120 may maintain the reference point 372₋₁ to 372₂ of each window 370₋₁ to 370₂ on the view line 396. As such, the controller 120 may adjust or shift each window 370₋₁ to 370₂ with respect to a stationary window 370₀ associated with the origin layer 340₀ based on spatial movement of the tablet 100 and its associated depth along the z-axis.

The controller 120 at 650 may generate one or more output signals which cause the display device 130 to display an updated presentation 360C of the multilayer image 330. In particular, the controller 120 may generate a composite presentation of the layers 340₋₁ to 340_{N} that accounts for the shift in view windows 370₋₁ to 370₂ and regions of upper layers overlapping and hiding regions of lower layers. In this manner, the controller 120 may cause the display device 130 to display a presentation 360C of the image 330 that is based on the associated depth and the associated offset for each layer 340₋₁ to 340_{N} of the multilayer image 330.

It should be appreciated that the above shifting of the two-dimension regions of the layers 340₋₁ to 340_{N} in response to spatial movement of the tablet 100 generates a three-dimensional effect. In particular, a user may tilt the tablet 100 to explore the image 330 and uncover aspects that are hidden by other aspects of the image 330 that are in the foreground. For example, the image 330 may have a pirate theme in which a treasure chest that is hidden or partially hidden behind an island is revealed when the tablet 100 is tilted in an appropriate manner.

Various embodiments of the invention are described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a computer readable storage medium such as, for example, flash memory devices, hard disk devices, compact disc media, DVD media, EEPROMs, etc. Such instruction when executed by a electronic tablet device or other computing device, may enable the creation and/or editing of images via spatial movement (e.g., up, down, left, right, tilting, shaking, etc.) of the computing device itself.

One skilled in the art would readily appreciate that many modifications and variations of the disclosed embodiments are possible in light of the above teachings. Thus, it is to be understood that, within the scope of the appended claims, aspects of the disclosed embodiments may be practiced in a manner other than as described above.

What is claimed is:

1. A method, comprising:
displaying, on a display of an electronic device, a first presentation of a multilayer image that is based on an associated depth and an associated offset for each layer of the multilayer image;
adjusting, with the electronic device, the offset for each layer of the multilayer image based upon spatial movement of the electronic device and its associated depth; and
displaying, on the display of the electronic device, a second presentation of a multilayer image that is based on the associated depth and the associated adjusted offset for each layer of the multilayer image.

2. The method of claim 1, wherein:
said adjusting comprises determining the offset for each layer based on its depth from a reference layer of multilayer image that remains stationary; and shifting a viewing window for each layer of the multilayer image with respect to a stationary viewing window for the reference layer based on the associated offset for the respective layer; and
said displaying a second presentation comprises displaying a portion of each layer of the multilayer image within its viewing window.

3. The method of claim 1, wherein:
said adjusting comprises determining the offset for each layer based on its depth from a stationary viewing window; and shifting a viewing window for each layer of the multilayer image with respect to the stationary viewing window based on the associated offset for the respective layer; and
said displaying a second presentation comprises displaying a portion of each layer of the multilayer image within its viewing window.

4. The method of claim 3, wherein said shifting a viewing window comprises shifting the viewing window both horizontally and vertically with respect to the stationary viewing window.

5. The method of claim 1, further comprising:
selecting a color based on first input signals received via a touch sensor;
selecting a region of a layer of the multilayer based on second input signals received via the touch sensor; and
filling the selected region of with the selected color in response to the second input signals.

6. The method of claim 1, further comprising:
selecting a color based on first input signals received via a touch sensor;
selecting a region of a layer of the multilayer based on second input signals received via the touch sensor that correspond to a visible portion of the selected region; and
filling both the visible portion and a hidden portion of the selected region of with the selected color in response to the second input signals.

7. An apparatus, comprising:
a display defining configured to display a multilayer image based on one or more output signals;
a motion sensor configured to generate one or more input signals indicative of a spatial movement of the apparatus; and
a controller configured to generate one or more output signals that present, on the display, a first presentation of the multilayer image that is based on an associated depth and an associated offset for each layer of the multilayer image, to adjust the offset for each layer of the multilayer image based on the one or more input signals, and generate one or more output signals that present, on the display, a second presentation of the multilayer image on the display that is based on the associated depth and the associated adjusted offset for each layer of the multilayer image.

8. The apparatus of claim 7, wherein the controller is further configured to determine, based on the one or more input signals, a direction in which the apparatus is tilted, and adjust the offset for each layer based on the determined direction.

9. The apparatus of claim 7, wherein the controller is further configured to determine, from the one or more input signals, a direction and a magnitude in which the apparatus is tilted, and adjust the offset for each layer based on the determined direction and magnitude.

10. The apparatus of claim 7, wherein the controller is further configured to:
determine the offset for each layer based on its depth from a reference layer of multilayer image that remains stationary; and
shift a viewing window for each layer of the multilayer image with respect to a stationary viewing window for the reference layer based on the associated offset for the respective layer; and
generate the one or more output signals for the second presentation based on a portion of each layer of the multilayer image within its viewing window.

11. The apparatus of claim 7, wherein the controller is further configured to:
determine the offset for each layer based on its depth from a stationary viewing window;
shift a viewing window for each layer of the multilayer image with respect to the stationary viewing window based on the associated offset for the respective layer; and
generate the one or more outputs signals for the second presentation based on a portion of each layer of the multilayer image within its viewing window.

12. The apparatus of claim 11, wherein the controller is further configured to shift the viewing window for a layer of the multilayer image both horizontally and vertically with respect to the stationary viewing window.

13. The apparatus of claim 7, further comprising:
a touch sensor configured to generate touch input signals indicative location on the display;
wherein the controller is further configured to select a color based on first touch input signals received via the touch sensor, select a region of a layer of the multilayer image based on second touch input signals received via the touch sensor, and fill the selected region of with the selected color in response to the second touch input signals.

14. The apparatus of claim 7, further comprising:
a touch sensor configured to generate touch input signals indicative location on the display;
wherein the controller is further configured to select a color based on first touch input signals received via the touch sensor, select a region of a layer of the multilayer image based on second touch input signals received via the touch sensor that correspond to a visible portion of the selected region, and fill both the visible portion and a hidden portion of the selected region of with the selected color in response to the second touch input signals.

15. A computer readable storage medium, comprising a plurality of instructions, that in response to being executed, cause an electronic tablet device to:
display a first presentation of a multilayer image that is based on an associated depth and an associated offset for each layer of the multilayer image;
adjust the offset for each layer of the multilayer image based upon spatial movement of the electronic device and its associated depth; and
display a second presentation of a multilayer image that is based on the associated depth and the associated adjusted offset for each layer of the multilayer image.

16. The computer readable storage medium of claim 15, wherein the plurality of instructions further cause the electronic tablet device to:
determine the offset for each layer based on its depth from a reference layer of multilayer image that remains stationary;
shift a viewing window for each layer of the multilayer image with respect to a stationary viewing window for the reference layer based on the associated offset for the respective layer; and
display a portion of each layer of the multilayer image that lies within its viewing window.

17. The computer readable storage medium of claim 15, wherein the plurality of instructions further cause the electronic tablet device to:
determine the offset for each layer based on its depth from a stationary viewing window;
shift a viewing window for each layer of the multilayer image with respect to the stationary viewing window based on the associated offset for the respective layer; and
display a portion of each layer of the multilayer image that lies within its viewing window.

18. The computer readable storage medium of claim 17, wherein the plurality of instructions further cause the electronic tablet device to shift the viewing window both horizontally and vertically with respect to the stationary viewing window.

19. The computer readable storage medium of claim 15, wherein the plurality of instructions further cause the electronic tablet device to:
select a color based on first input signals received via a touch sensor;
select a region of a layer of the multilayer based on second input signals received via the touch sensor; and
fill the selected region of with the selected color in response to the second input signals.

20. The computer readable storage medium of claim 15, wherein the plurality of instructions further cause the electronic tablet device to:
select a color based on first input signals received via a touch sensor;
select a region of a layer of the multilayer based on second input signals received via the touch sensor that correspond to a visible portion of the selected region; and
fill both the visible portion and a hidden portion of the selected region of with the selected color in response to the second input signals.
